(19) United States
(12) Patent Application Publication
(10) Pub. No.: US 2004/0197041 A1
(43) Pub. Date: Oct. 7, 2004

(54) Method to realize phase difference in cascaded coupler devices

(76) Inventors: Erlian Lu, Milpitas, CA (US); Yingxiang Kang, Fremont, CA (US); Yuanxin Shou, Milpitas, CA (US)

Correspondence Address: Erlian Lu, 841 Horcajo St., Milpitas, CA, 95035, US

(21) Appl. No.: 10/408,155

(22) Filed: Apr. 4, 2003

(51) Int. Cl. G02F 1/035; G02B 6/26

(52) U.S. Cl. 385/3; 385/39

(57) ABSTRACT

An unbalanced Mach-Zehnder interferometer for performing an optical filter on a plurality of optical functions is provided. The interferometer includes a first and second fused tapered couplers to split and combine the light beam. A phase difference media made of glass with different refractive index is inserted between two couplers. This kind of structure can achieve reproducibility and environmental stability such as temperature changes and random bending forces.

### FIELD OF THE INVENTION

This invention relates to improvement of performs of optical fiber filter and more particularly to narrow band optical fiber filter used for fiber amplifier system, Dense Wavelength Division Multiplexing (DWDM) communication system, Coarse Wavelength Division Multiplexing (CWDM) communication system and networks.

### BACKGROUND OF THE INVENTION

Fused fiber couplers can be used as power splitters, wavelength combiner filters and wavelength channel filters and so on. All those applications are based on the coupler's interferometer characteristics. The coupler can be considered as a super-structure waveguid and support two super-modes that are beating each other in the waist of coupler. The output power distribution depends on the phase difference between the two super-modes. For the narrow passband filter (few nanometers), it requires very large phase difference between the two super-modes, which causes the PDL and stable issues in the couplers fabrication process. The alternative way is to cascade two couplers with un-balanced arms to form the large phase difference. This structure is called un-balanced Mach-Zehnder filter. Further more, to realize the flat top filter shape, it requires three or more couplers to cascade together to form a series of phase difference.

The cascaded coupler chain can be made by planar waveguid or by the fused fiber couplers. Due to the material un-stability, and power loss issue, the planar waveguid narrow band filters have not be used in practices. The cascaded fused fiber coupler structure was realized by splicing a few fused and tapered couplers together with different arm length. However, during the package process, the longer arm fiber must be bent. This causes the stress in fiber that will gradually release in long time. This effect causes the filter channel central wavelength shift in the long-term reliability test. Accordingly, there is a need for a new method to realize the phase difference and further to fabricate the high performance fiber devices.

U.S. Pat. No. 6,185,345 (Singh et al), issued Feb. 6, 2001, discloses an unbalanced Mach-Zehnder interferometer with maintaining a relative delay between the first and second waveguide at a constant value by automatically compensating for any change in signal drift. However, such method requires real time monitor and signal process, this will increase the cost and reduce its reliability. Moreover, such method requires special metal coating on fiber, then doing the stress or temperature compensation, due to weak effect of stress and temperature effect on fiber, the whole device can't be to small.

It is therefore an object of the invention to provide an optical device that is the environment stable and passive. It is further object of the invention to provide such a device which functionality may be conveniently and dynamically so that it is economical and affords ease of fabrication.

### OBJECTS AND SUMMARY OF THE INVENTION

In according with the present invention, a new method to form a constant phase difference in cascaded fused fiber couplers structure is disclosed. Instead of the unbalanced arm length, the invention uses two equal length pieces of glass with the different refractive index to realize the phase difference. The advantage of this method is to eliminate the stress to keep the long-term stability. Moreover, by properly selecting materials that have the same refractive index response with temperature, it can keep the phase difference constantly during the temperature variation. Moreover, by dedicated designing the phase difference media structure and bonding it on a movable part, this device can perform as various kinds of active devices. In addition, this method can be universally used in various applications such as wavelength combiner, CWDM filter, interleave, gain flatten filter, attenuator, switch and so on. Consequently, the devices using this method are highly manufacturable by mass production.

### BRIEF DESCRIPTION OF THE DRAWINGS

FIG. 1. schematically illustrates an embodiment of the phase difference formation.

FIG. 2. schematically illustration of one approach to form phase delay path in cascaded couplers chain.

FIG. 3 schematically illustrates a hybrid Mach-Zehnder filter (HMZF) according to the present invention.

FIG. 4 represents modification of FIG. 3 of present invention involving application in cascaded coupler chain.

FIGS. 5A and 5B are diagrams showing two embodiments of implementations such as 2×2 optical switch and attenuator of present invention.

It is to be understood that these draws are for purposes of illustrating the concepts of the invention and are not to scale.

### DETAILED DESCRIPTION OF THE INVENTION

This description is divided into three parts. In part I, we describe the basic structure of a simple filter in accordance with our invention. In part II, we describe the physical fabrication of the filter. In part III, we describe the configuration to realize the various kinds of filters and their applications.

1. Basic Structure

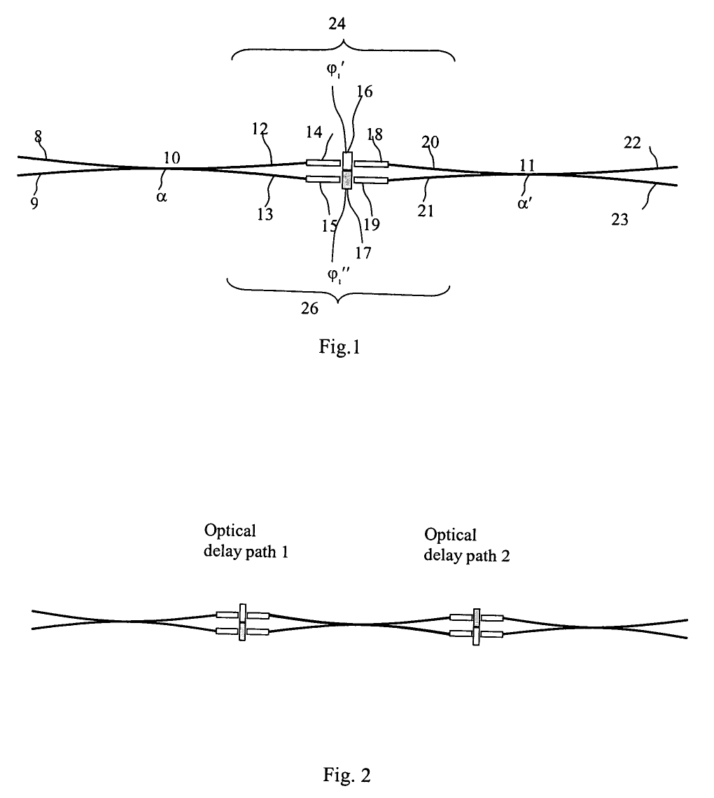

An embodiment of this invention is schematically shown in FIG. 1 to illustrate “Hybrid Mach-Zehnder Filter (HMZF)”, that the working principles are similar to that described in U.S. Pat. No. 6,185,345. The differences between present and previous inventions are in the formation of phase difference. Two couplers 10 and 11 are connected through one arm (or phase delay path) 24 which consists of two segments of single mode fiber 12 and 20, two segments of multi-mode fiber 14 and 18, an optical media 16. The other arm 26 comprises two segments of single mode fiber 13 and 21, two segments of multi-mode fiber 15 and 19, and an optical media 17. The lengths of single mode and multi-mode fiber are equivalent in both arms, and the optical media 16 and 17 have the same length but different reflective index. The phase difference is just caused by this index difference between two optical medias. By this way, the two arms between couplers have the same length that will be convenient for assembling coupler module and keep the filter have stable preferment.

For a single coupler, its function can be described by a transfer matrix

$$T = {ⅇ}^{ⅈ \overline{α}} [ \begin{matrix}cos α & sin α \\ ⅈ sin α & cos α\end{matrix} ] \qquad ( 1 )$$

where α is phase difference when two super-modes pass through whole coupler. The phase delay between two couplers can be described by a transfer matrix

$${T}_{ϕ} = [ \begin{matrix}{ⅇ}^{ⅈ {ϕ}_{1}^{′}} & 0 \\ 0 & {ⅇ}^{ⅈ {ϕ}_{1}^{″}}\end{matrix} ] \qquad ( 2 )$$

For a Mach-Zehnder structure, its transfer Matrix

$${T}_{2 \times 2} = {T}_{2 \times 2} ( {α}^{′} ) [ \begin{matrix}{ⅇ}^{ⅈ {ϕ}_{1}^{′}} & 0 \\ 0 & {ⅇ}^{ⅈ {ϕ}_{1}^{″}}\end{matrix} ] {T}_{2 \times 2} ( α ) \qquad ( 3 )$$

Power transmission

$$\begin{matrix}{P}_{1} = \frac{1}{2} [ 1 + cos 2 α cos 2 {α}^{′} - sin 2 α sin 2 {α}^{′} cos δ ϕ ] \\ {P}_{2} = \frac{1}{2} [ 1 - cos 2 α cos 2 {α}^{′} + sin 2 α sin 2 {α}^{′} cos δ ϕ ]\end{matrix} \qquad ( 4 )$$

where δφ=φ₁′−φ₁″. If the two arms have equal length, the phase difference is caused by the difference of reflective index δn or the propagation constant difference δφ=δβL. Through properly approximation, the channel bandwidth of Mach-Zehnder can be expressed as

$$δ λ = \frac{{λ}^{2}}{2 L δ n} \qquad ( 5 )$$

So, the filter channel space depends on the optical media length and their index difference. For example, for 50 GHz channel space, the bandwidth is 0.4 nm, and if the optical media index difference is 1.5, the optical media length is about 2 mm.

FIG. 2 shows another embodiment that comprises three couplers and two phase-delay paths. This structure has the function same as above one but produces a flat top filter shape. This phase delay path can also be used in more cascaded coupler chain to form different phase differences suitable for various kinds of application.

2. Fabrication

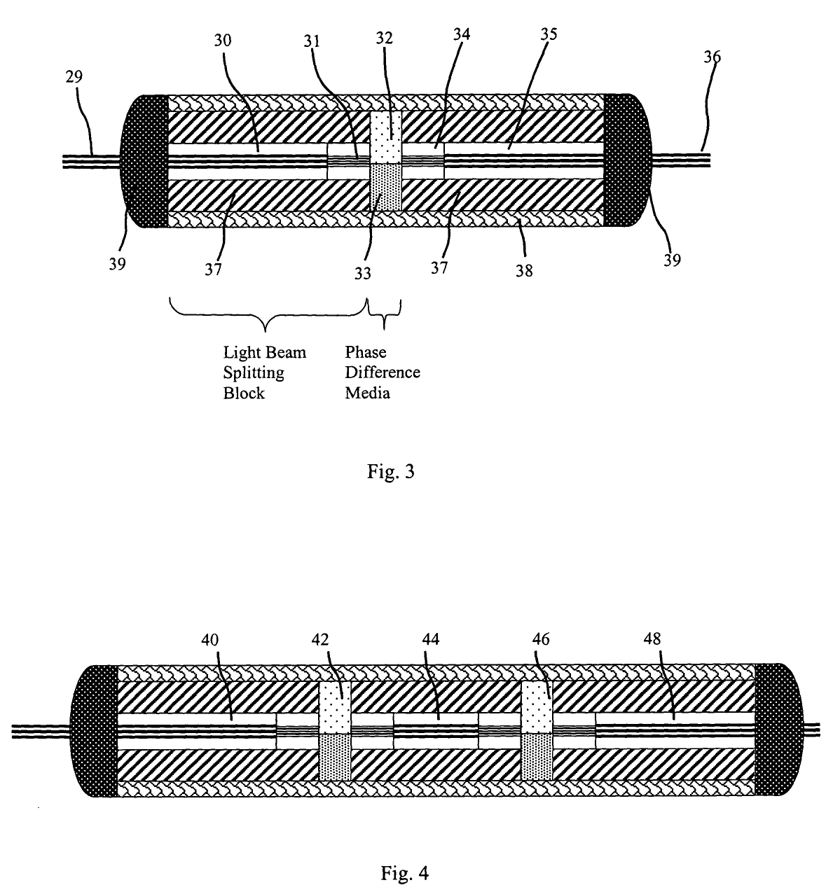

FIG. 3 shows the practical embodiment of a simple device. The fused fiber coupler can be built with normal production process and bonded on standard cylinder substrate 30 with O.D. of 1.8 mm. The two output fibers of coupler are spliced to a multimode fiber that has a gradient index profile and function as collimate lens. The two multi-mode fibers are sealed in a capillary tube 31 with O.D. of 1.8 mm. The coupler and capillary tube are inserted into a thick glass tube 37 with I.D. of 1.8 mm and O.D. of 10 mm. The polish work need to do on the capillary tube free end-face and the multi-mode fiber length need to be controlled in around 0.25 pith for the operating light wavelength to form the parallel light beam. This whole large tube called “light beam splitting block (LBSB)”. Then this block is stick to the “phase difference media (PDM)” that consists of two different reflective indices 32 and 33 in each side. Another revised “light beam splitting block” will be glued behind this phase difference media. To obtain accurate channel central wavelength and channel bandwidth, it can use UV laser exposure phase delay media 32 or 33 and multi-mode fiber or single mode fiber in coupler to do the fine trim. An alternative method is to use the thermal expanded core (TEC) fiber to replace multi-mode fiber. That means, the fiber end of coupler need to be treated with heat source to expend the fiber core diameter or simply use the commercial Grin lens to replace multi-mode fiber. Finally, the two blocks and one media are sealed in metal tube 38 with epoxy 39 to form a Mach-Zehnder filter.

The basic structure of our filter consists of two couplers and one phase delay path. Actually, to form flat top filters, it at least needs three couplers and two phases delay path that have different phase difference values. In FIG. 4 shows a three-stage filter consists of three couplers 40, 44, and 48 and two phases difference media 42 and 46. In practice, the filter may consist of a chain of N arbitrary couplers and N-1 phase delay paths. From the point of fabrication view, the fabrication considerations are the same as one block.

3. Application Configuration

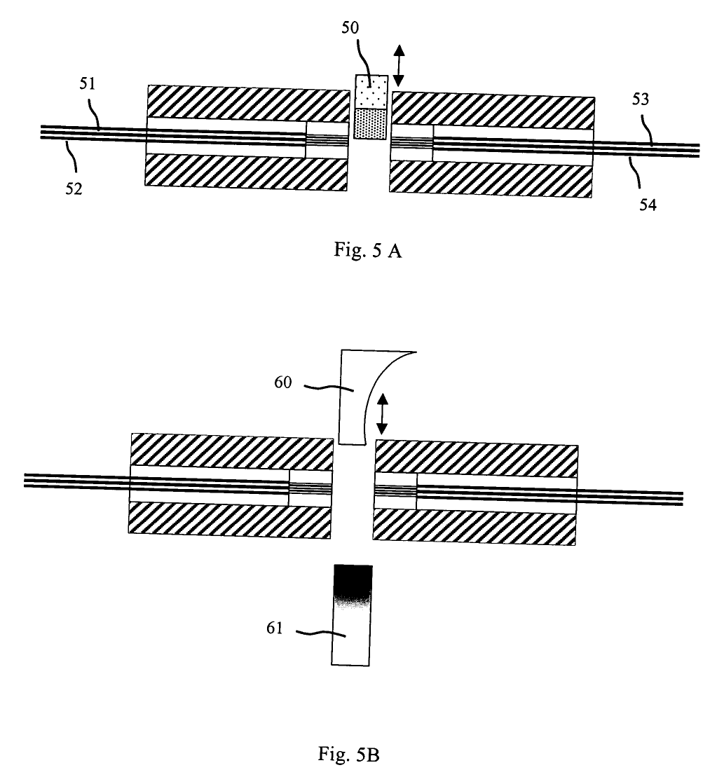

Because the function of phase difference caused by arm length difference or reflective index difference is the same, all the applications employed by arm length difference method can be realized by reflective difference method, such as WDM filter, interleaver, gain flatten filter listed in U.S. Pat. Nos. 5,852,505, 6185345, 6341186, and 5809190. Besides, HMZF can also function as an active component. For example, in FIG. 5A, if the two couplers are identical wide-band 3 dB coupler, the light coming from port 51 will go to port 54 without the phase difference media or go to port 53 when inserting π phase difference media. Similarly, the light coming from port 52 will go to port 53 without phase difference and will go to port 54 if inserting the phase difference media. If the π phase difference media 50 is bonded on step motor or PZT, one can construct a 2×2 switch through moving the phase difference media in and out.

One can also contract a variable optical attenuator with a gradient variable phase difference media bonded on step motor or PZT. According to equation (4), for 3 dB coupler, α=α′=π/4, the HMZF transmission are

$$\begin{matrix}{P}_{1} = \frac{1}{2} ( 1 - cos δ ϕ ) \\ {P}_{2} = \frac{1}{2} ( 1 + cos δ ϕ )\end{matrix} \qquad ( 6 )$$

when phase difference changes from 0 to π, the transmission power will vary from 0 to 100%. The phase difference media can be formed a parabolic shape crystal or glass 60, or plan media with parabolic index profile 61.

It is to be appreciated and understood that the above-described embodiments are illustrative of only a few of the many possible specific embodiments that can represent applications of the principles of the present invention. Numerous and varied other filter arrangements can be made by those skilled in the art without departing from the spirit and scope of the invention.

What is claimed is:

1. An hybrid Mach-Zehnder filter (HMZF) comprising:
A light beam splitting block (lbsb) perform the split of light power and expend the light beam spot size:
A phase difference media (PDM) formed by crystal or glass with different refractive index to produce the phase different between two light beams.
A light beam combining block (LBCB) perform the combing two light beam and produce the light interfere phenomena.

2. An hybrid Mach-Zehnder filter in claim 1 further including a light beam splitting block which comprising:
A 3 dB fused fiber coupler splitting the input light into two equal two beams. The output fiber ends of the said coupler is treated by heat source to form a larger fiber core, or said the thermal expended core (TEC), the said larger core expand the light beam spot size and form the quasi collimated light beam. The said fiber ends are polished and coated with anti-reflection film.

3. The light beam splitting block defined as in claim 2 can also be formed by splice a segment multi-mode fiber with gradient index profile to the output fiber end of 3 dB coupler. The length of the multi-mode fiber is about 0.25 pith so that the light beam is collimated.

4. The light beam splitting block defined as in claim 2 can also be formed by adheres a segment Grin lens to the output fiber end of 3 dB coupler. The length of the Grin lens is about 0.25 pith so that the light beam is collimated.

5. An hybrid Mach-Zehnder filter in claim 1 further including a phase difference media that comprising: A high refractive media with relative high refractive index and a low refractive media with relative low refractive index. Both media have the plan shape and equal geometric length but different index. The materials for this media are crystal, glass and other transparent materials.

6. The phase difference media in claim 5 wherein its phase difference is π. A method of UV laser or thermal source exposing on light beam splitting block or phase media to do the fine phase difference adjustment.

7. An optical 2×2 switch based on HMZF comprising:
A light beam splitting block perform to split input light beam into two equal light beam.
A movable phase difference media that is bonded on step motor or PZT is controlled by remote signal. Wherein the said phase difference value is π or nπ, n is integer value.
A light beam combining block to combine two light beam into a coupler region to form a filter.

8. An optical attenuator based on HMZF comprising:
A light beam splitting block perform to split input light beam into two equal light beam.
A movable phase difference media that is bonded on step motor or PZT is controlled by remote signal. Wherein the said phase difference media has gradient deformation geometric shape, such as parabolic shape and other curvature shape. The said phase different media can also be the plan shape with gradient index profile such as parabolic distribute profile.
A light beam combining block to combine two light beam into a coupler region to form a filter.

9. An HMZF as defined in claim 1 comprising one light beam splitting block, one phase difference media and one light beam combining block. However several HMZF are cascaded with the phase difference as δφ, 2δφ, 3δφ . . . nδφ, and so on. It can form more narrow band and flat top filter such as DWDM filter and interleaver.
